(19) United States
(12) Patent Application Publication
(10) Pub. No.: US 2016/0293025 A1
(43) Pub. Date: Oct. 6, 2016

(54) ATTENDANCE TRACKING MOBILE READER DEVICE AND SYSTEM

(71) Applicant: BLACKBOARD INC., Washington, DC (US)

(72) Inventors: David MARR, Washington, DC (US); Bruce STAHL, Washington, DC (US); Kent PAWLAK, Washington, DC (US); Andrew HOCHSTETLER, Washington, DC (US); Steve FORBIS, Washington, DC (US); Tom KUESTERSTEFFEN, Washington, DC (US); Tim MATTSON, Washington, DC (US); Chris CHALLINOR, Washington, DC (US)

(21) Appl. No.: 15/091,529

(22) Filed: Apr. 5, 2016

Related U.S. Application Data
(60) Provisional application No. 62/143,768, filed on Apr. 6, 2015.

(51) Int. Cl. G09B 5/00

(52) U.S. Cl. CPC G09B 5/00

(57) ABSTRACT

An attendance tracking system including a memory storing commands and a processor is provided. The processor causes the system to receive class attendance data associated with a student from a personal computer device, including a course parameter and a student attendance parameter. The system verifies that the student is enrolled in the course associated with the course parameter and that the student attendance parameter includes a valid class time for the course. The system updates a course record for the course and a student record for the student based on the class attendance data. In some embodiments, the student record includes historical data representative of the student's attendance for the course. In some embodiments, the processor also causes the system to modify an access privilege of the student to a service provided by the institution based on the student record. A method for using the above system is also provided.

### CROSS REFERENCE TO RELATED APPLICATIONS

This application is related and claims priority under 35 U.S.C. §119 to U.S. Provisional Patent Application No. 62/143,768 entitled ATTENDANCE TRACKING MOBILE READER DEVICE AND SYSTEM, to Bruce Stahl, et al., filed on Apr. 6, 2015, the contents of which are hereby incorporated in their entirety by reference for all purposes.

### FIELD

The present disclosure is related to methods and systems to provide an accurate record of class attendance for reporting and evaluation purposes in academic environments.

### BACKGROUND

Class attendance is a core element in a student's ability to achieve desired academic goals. Current systems and methods for evaluating class attendance are cumbersome and involve manual labor and personal intervention by the professor, the student, and other personnel in the academic environment. Accordingly, time and effort that could be used for the intellectual component of the academic endeavor is used in clerical tasks, increasing costs and rendering performance evaluations prone to human error and/or abuse.

What is needed is a system and methods to automate and provide an accurate record of class attendance for reporting and evaluation purposes in academic environments.

### SUMMARY

In certain embodiments, an attendance tracking system for tracking class attendance by a student in an institution via a network is disclosed. The system includes a memory storing commands and a processor configured to execute the commands stored in the memory. Accordingly, upon execution of the commands, the processor causes the attendance tracking system to receive a class attendance data associated with the student from a personal computer device, the class attendance data comprising a course parameter and a student attendance parameter. The processor also causes the system to verify that the student is enrolled in the course associated with the course parameter and that the student attendance parameter includes a valid class time for the course, and to update, based on the course parameter and the student attendance parameter, a course record for the course and a student record for the student. In some embodiments, the student record includes historical data representative of the student's attendance for the course, and the course record and the student record are stored in the memory. In some embodiments, the processor also causes the system to modify an access privilege of the student to a service provided by the institution based on the student record.

In certain embodiments, a computer implemented method for tracking class attendance by a student in an institution via a network server is disclosed. The method includes receiving a class attendance data associated with the student from a personal computer device, the class attendance data comprising a course parameter and a student attendance parameter. In certain embodiments, the method includes verifying that the student is enrolled in the course associated with the course parameter and that the student attendance parameter includes a valid class time for the course, and updating, based on the course parameter and the student attendance parameter, a course record for the course and a student record for the student. In certain embodiments, the student record includes historical data representative of the student's attendance for the course. In certain embodiments, the computer implemented method also includes modifying an access privilege of the student to a service provided by the institution based on the student record and storing performance criteria to add or subtract points to a score in the student record. In some embodiments, and according to the established performance criteria, the method includes triggering a supplemental action to reward or penalize the student according to the score in the student record accrued after a period of time.

### BRIEF DESCRIPTION OF THE FIGURES

FIG. 1 describes an architecture for an attendance tracking system including a server hosting an attendance rules engine and a card reader device, according to some embodiments.

FIG. 2 describes a block diagram of the architecture for an attendance tracking system in FIG. 1, according to some embodiments.

FIG. 3 describes a circuit in a mobile reader device for use in an attendance tracking system, according to some embodiments.

FIG. 4 describes a user display for an administrator creating a course and a course timeline in a system according to some embodiments.

FIG. 5 describes a user display for an administrator exporting a bulk of attendance data in a system according to some embodiments.

FIG. 6 describes a user display for an administrator accessing a card for a student in a system according to some embodiments.

FIG. 7 describes a user display to manage the configuration of a reader device in a system according to some embodiments.

FIG. 8 describes a user display for an administrator creating a collection of classes in a system according to some embodiments.

FIG. 9 describes a user display for an instructor viewing an attendance taken for a first day of class in a term, according to some embodiments.

FIG. 10A describes a user display for an administrator performing data maintenance in a system according to some embodiments.

FIG. 10B describes a user display for an administrator including users in a system according to some embodiments.

FIG. 11 describes a user display for viewing and editing institution information in a system according to some embodiments.

FIG. 12A-F describe a user display for an instructor registering a personal computer device in a system according to some embodiments.

FIG. 13A-C describe a user display for a tools configuration in a system according to some embodiments.

FIG. 14 describes a flow chart with steps in a method for tracking class attendance by a student in an institution via a network server using a mobile reader device, according to some embodiments.

FIG. 15 describes a block diagram illustrating an example computer system with which the personal computing device and server of FIG. 1 can be implemented, according to some embodiments.

In the figures, elements having the same or similar reference numeral are associated with elements or steps have the same or similar description unless otherwise indicated.

### DETAILED DESCRIPTION

In the following detailed description, numerous specific details are set forth to provide a full understanding of the exemplary embodiments. It will be obvious, however, to one ordinarily skilled in the art that the embodiments may be practiced without some of these specific details. In other instances, well-known structures and techniques have not been shown in detail so as not to obscure the embodiments.

As generally used herein, the term “outcome” is the achieved result or consequence of some activity (e.g. instruction or some other performance). Frequently, the term is used with a modifier to clarify the activity. An “institutional level outcome” is an outcome that is the achieved result or consequence of some activity as determined at an educational institutional level. A “program level outcome” is an outcome that is the achieved result or consequence of participating in and/or successfully completing an educational program, wherein the program may include one or more educational courses (e.g., for a degree program or certificate program). A “course level outcome” is the achieved result or consequence of participation in a particular educational course of study (e.g., a Calculus I class, an American Literature class, etc.).

In embodiments consistent with the present disclosure the attendance record for a student may be an important factor in order to evaluate a student progress to obtain the desired learning outcome. These outcomes may relate, for example, to institutional level outcomes, program level outcomes, and course level outcomes. A student identification credential or an electronic device may be associated with a student that may contain student data or other student information. The card or device may be swiped, read by a proximity reader, engaged in an interchange of information based on a received request, or be subject to any other registration by the system. This swiping or interchange of information may provide a record of, for example, how frequently a student has attended class, visited the library, utilized entertainment offerings on- or off-site from an educational campus, participated in educational online organizations, attended educational events or lectures, utilized off campus merchants, or any other suitable activities. Alternatively, student information data may be captured at a login event for an educational institution computer network, or with the submission of an electronic document for educational or administrative purposes.

In certain embodiments of the disclosure, a device for recording a student attendance to a class is provided. The device includes a processor configured to receive, from a student, an attendance signal. The processor is further configured to transmit, to a user personal computer device, an attendance mark for the student in response to the attendance signal. The attendance mark is also stored in a memory of the device. The attendance signal is triggered by an identification carrier handled by the student.

The present disclosure describes methods and systems for attendance tracking following desirable academic transaction procedures. Some embodiments include a database for attendance tracking. Some embodiments include a web application built on a cloud service platform hosted by a server. The server architecture involves data structures and executable commands in an application integrated within an object-relational mapping (ORM) framework.

In a first embodiment, an attendance rules engine for tracking class attendance by a student in an institution via a network server is configured to receive a class attendance data associated with the student from a personal computer device, the class attendance data comprising a course parameter and a student attendance parameter. The attendance rules engine is also configured to verify that the student is enrolled in the course associated with the course parameter and that the student attendance parameter includes a valid class time for the course, and to update, based on the course parameter and the student attendance parameter, a course record for the course and a student record for the student. The student record may include historical data representative of the student's attendance for the course. The attendance rules engine is also configured to modify an access privilege of the student to a service provided by the institution based on the student record.

In a second embodiment, a computer implemented method for tracking class attendance by a student in an institution via a network server includes receiving a class attendance data associated with the student from a personal computer device, the class attendance data including a course parameter and a student attendance parameter. The computer implemented method includes verifying that the student is enrolled in the course associated with the course parameter and that the student attendance parameter includes a valid class time for the course and updating, based on the course parameter and the student attendance parameter, a course record for the course and a student record for the student, the student record comprising historical data representative of the student's attendance for the course. The computer implemented method may also include modifying an access privilege of the student to a service provided by the institution based on the student record and storing performance criteria to add or subtract points to a score in the student record. Further, according to the established performance criteria, the method may include triggering a supplemental action to reward or penalize the student according to the score in the student record accrued after a period of time.

In a third embodiment, a non-transitory, computer-readable storage medium stores instructions, which when executed by a processor in a computer, cause the computer to execute a method including receiving a class attendance data associated with the student from a personal computer device, the class attendance data comprising a course parameter and a student attendance parameter. The method also includes verifying that the student is enrolled in the course associated with the course parameter and that the student attendance parameter includes a valid class time for the course, and updating, based on the course parameter and the student attendance parameter, a course record for the course and a student record for the student. The student record includes historical data representative of the student's attendance for the course, modifying an access privilege of the student to a service provided by the institution based on the student record, and storing performance criteria to add or subtract points to a score in the student record. According to the established performance criteria, the method may include triggering a supplemental action to reward or penalize the student according to the score in the student record accrued after a period of time, wherein the service provided by the institution is one of counseling, an extra course credit, lab time, or access to a campus facility.

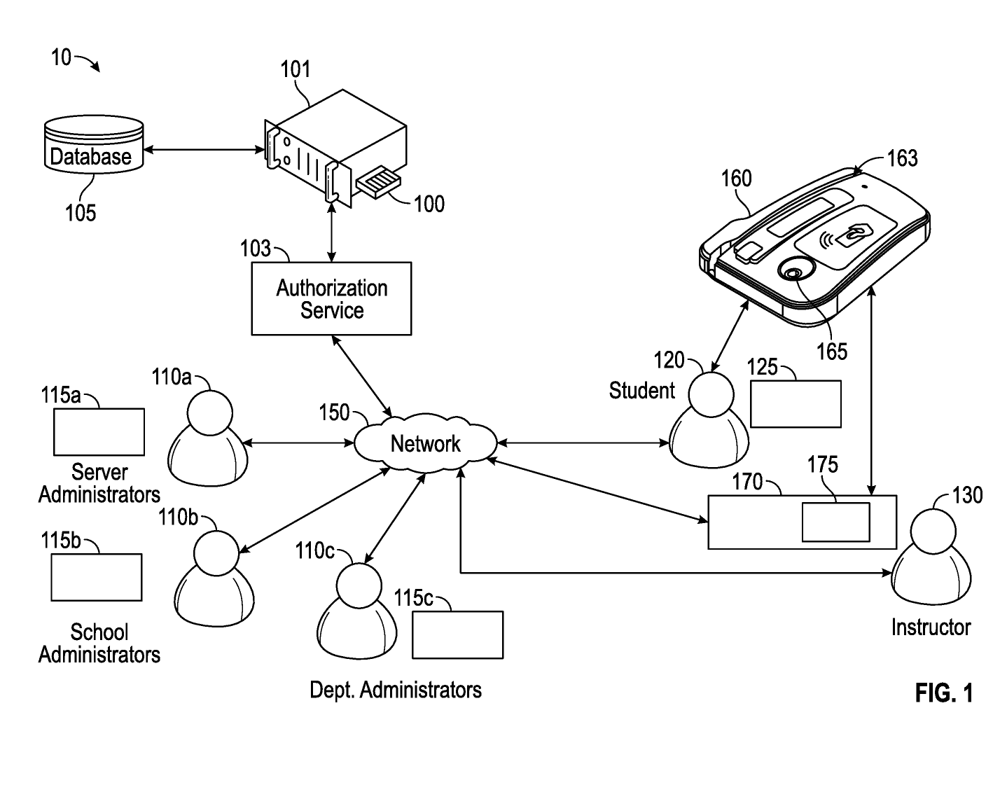

FIG. 1 describes an architecture for attendance tracking system 10 including a server 101 hosting an attendance rules engine 100, and a card reader device 160, according to some embodiments. Server 101 includes an attendance rules engine 100 and is coupled to an authorization service 103 module. Tracking system 10 includes a student 120 attending a class in a course imparted by an instructor 130. Student 120 engages reader device 160 with an identification credential 125 at a class check-in time. Reader device 160 may be a mobile device located at or near a classroom entrance. In some embodiments, reader device 160 may be brought to the classroom by instructor 130. In some embodiments, reader device 160 operates as a peripheral device to a host such as a smart phone or tablet with communication being provided over USB or Bluetooth Low Energy (BLE). The host may be a personal computer device 170 under the control of instructor 130. Accordingly, in some embodiments each instructor may carry reader device 160 around, from one class to another class. In some embodiments, reader device 160 may be temporarily or permanently fixed to a classroom. Accordingly, reader device 160 may be configured to be hosted by a plurality of personal computer devices 170 associated with a plurality of instructors 130 who teach a class in the classroom.

Embodiments of reader device 160 consistent with the present disclosure have a small form factor and fit in a pocket or purse, or comfortable fit into an adult's hand in case instructor 130 desires to carry it around from one class to the next. One of ordinary skill will recognize that reader device 160 may be configured to read the latest contactless communication technologies including MIFARE®, DESFire® and FeliCa™, without limitation Furthermore, reader device 160 may incorporate other, more traditional communication protocols such as NFC, magnetic strip and others. For example, in some embodiments reader device 160 may be BLE, enabled. In some embodiments, reader device 160 is wireless and has a rechargeable battery rated at 40 hours, or it can be directly powered from a wall plug.

In some embodiments, student 120 may engage reader device 160 with identification credential 125 once again at a class check-out time to log in a more accurate value for class attendance. Student 120 may be one of a plurality of students registered for a course provided by an academic institution registered with server 101. Likewise, instructor 130 may be one of a plurality of instructors working in the academic institution.

Other users that may have access to attendance rules engine 100 and server 101 may include a server administrator 110a, a school administrator 110b, and a department administrator 110c (hereinafter collectively referred to as administrators 110). Server administrator 110a may access server 101 through network 150 using a personal computer device 115a. Server administrator 110a may access server 101 to perform maintenance procedures including software updates, policy checks, and security updates. School administrator 110b may access server 101 through network 150 using a personal computer device 115b. School administrator 110b may access server 101 to review attendance data and policies stored in database 105 and associated with an academic institution registered with server 101 and for which school administrator 110b has access credentials. Department administrator 110c may access server 101 through network 150 using a personal computer device 115c. Department administrator 110c may access server 101 to review attendance data associated with a specific department within an academic institution registered with server 101. Personal computer devices 115a-c will be hereinafter collectively referred to as administrator computer devices 115. Accordingly, personal computer devices 115 may be any one of a desktop computer, a portable computer, a laptop, a tablet, a smart phone, and the like.

In embodiments consistent with the present disclosure, administrators 110 may have different access privileges to server 101 and database 105. For example, a server administrator 110a may have global access and control of attendance rules engine 100 and of database 105. A school administrator 110b may have access only to portions of database 105 and of attendance rules engine 100 associated with the academic institution for which school administrator 110b has credentials. Department administrator 110c may have access to portions of database 105 associated with courses provided by a specific department within the academic institution. Likewise, student 120 and instructor 130 may have a differentiated access to server 101 and database 105.

Student 120 engages card reader device 160 using identification credential 125 to register attendance to a class or event imparted by instructor 130 at a check-in time. Card reader device 125 may be a magnetic card or an RFID card. For example, identification credential 125 may include a magnetic stripe and student 120 engages card reader device 160 by swiping the card through a notch 163. In some embodiments, student 120 may wave the RFID card in the vicinity of card reader device 160 to engage it. Further according to some embodiments, identification credential 125 may be embedded within a near field communication (NFC) circuit in a personal computer device used by student 120, such as a smartphone. Accordingly, student 120 may engage card reader device 160 by lightly tapping a smartphone on an NFC circuit 165 in card reader device 160. In such configurations, NFC circuit 125 may be configured to engage reader device 160 even when the personal computer device of student 120 is in sleep mode. Accordingly, in some embodiments the student may not need to turn the personal computer device fully ‘on,’ or launch a specific application to engage reader device 160. In some embodiments, a reader application 175 running in a personal computer device 170 handled by instructor 130 follows a store-and-forward approach for providing offline usage. For example, in some embodiments reader application 175 in personal computer device 170 downloads cardholder data from card reader device 160, course data, and course assignment data based on configured device profiles and keeps the data on a memory storage of personal computer device 170, for offline usage. In some embodiments, attendance data captured at class time by card reader device 160 is stored on personal computer device 170 and uploaded to attendance rules engine 100 in server 101 when connectivity through network 150 is or becomes available.

Authorization service (AS) module 103 protects and restricts access to server 101 by any one of student 120, instructor 130, or administrators 110. In some embodiments, a two-legged authorization model can be employed for authorization to access server 101. The two-legged model assumes that reader application 175 in personal computer device 170 is also the resource owner (RO). In that regard, reader application 175 communicates with attendance rules engine 100 via a consumer/client key and a secret pair of client credentials provided by AS module 103. These credentials may be encrypted by attendance rules engine 100 on the respective device platforms. In some embodiments reader application 175 signs the calls to attendance rules engine 100 per a signature specification using a consumer secret key. In some embodiments, an authorization request may include an empty token parameter. In some embodiments, AS module 103 generates client credentials employing a cryptographically secure pseudo random number generator (CSPRNG) to prevent replay attacks to attendance rules engine 100.

In some embodiments, AS module 103 employs grant type client credentials to realize the two legged authorization. Accordingly, an access token is acquired before making application program interface (API) requests. In some embodiments, the API consumer/client reader application authenticate against an AS endpoint for acquiring a scope and time limited access token. The authentication schema can be as simple as basic password authentication over hypertext transfer protocol secure (HTTPS)/top level specification (TLS) protocols. Accordingly, AS module 103 issues a scope and time limited access token upon authentication. It is desirable that consumer/client key is stored remotely in database 105 rather than locally on any one of card reader device 160, or personal computer devices 170 and 115. In some embodiments, reader application 175 is allowed to use a device profile download and attendance upload with further restrictions established by attendance rules engine 100 through authorization service 103. The profiles for each card reader device 160 registered with server 101 may be accessed and modified by attendance rules engine 100. In some embodiments, server 101 may include a device ID and a device password associated with personal computer device 170. Accordingly, attendance rules engine 100 may be configured to call back personal computer device 170 to request from instructor 130 an ID for card reader device 160 and/or a password, further enhancing access security. In some embodiments, attendance tracking system 10 reuses the endpoint deployed by AS module 103 as part of the system portal.

In some embodiments, multiple academic institutions may be registered for services provided by attendance rules engine 100. A configuration where attendance rules engine 100 serves a plurality of institutions is referred hereinafter as ‘multi-tenancy.’ In some instances, the number of registered academic institutions serviced by attendance rules engine 100 may grow significantly, demanding more frequent attendance records updates. Accordingly, some embodiments are configured to include a worker role with a queue between reader application 175 and a data tier to asynchronously update records in database 105 and mitigate scalability concerns. In some embodiments the data tier in database 105 employs a structured query language (SQL) server deployed on a virtual machine (VM). The application allows configuration changes and to switch execution and storage to multiple other database servers, according to the academic institution and to a deployment option. In some embodiments, a data tier code to manipulate data complies with relational database management system (RDBMS)-agnostic standard SQL. Some embodiments include representational state transfer (‘RESTful’) services to support a reader mobile solution with an appropriate application programming interface (API). Accordingly, RESTful services may be deployable as a separate component. In some embodiments, multi-tenancy is achieved via an appropriate schema design in the data tier that logically isolates each institution/tenant's data. Accordingly, some embodiments include an access control mechanism built into the application to ensure a tenant's ability to access their own data and not access other tenant's data, according to privileges and credential verification steps. Thus, embodiments consistent with the present disclosure include rigorous unit and system tests exercised through continuous integration.

Systems and methods as disclosed herein may include attendance tracking strategies incorporating a wireless communication protocol such as Wi-Fi, Bluetooth and the like, to further indicate the amount of time a student spends in the classroom during a certain class or event. For example, some embodiments include a Bluetooth low energy (BLE) “pinging” post check-in. Accordingly, once a student has checked-in by engaging card reader device 160, reader device 160 may be configured to “ping” the student's personal computer device during class, to ensure the student is still in attendance. With the initial NFC or BLE tap a relationship is built between the mobile device and card reader device 160. At a client configurable rate card reader device 160 will check to confirm the mobile device is still in range of card reader device 160. Checking will end at the scheduled course end time.

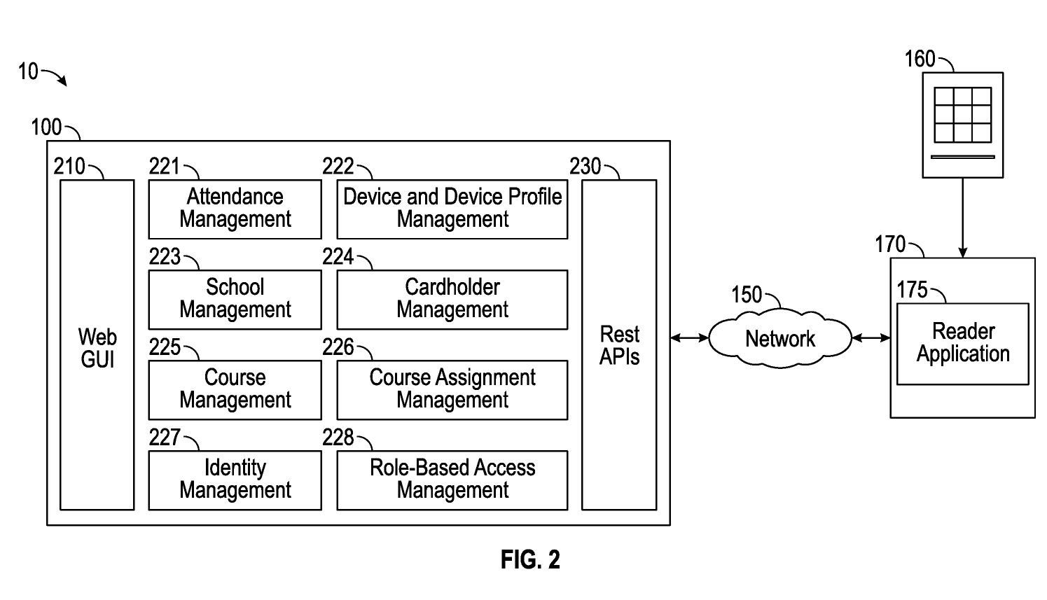

FIG. 2 describes a block diagram of the architecture for attendance tracking system 10 in FIG. 1, according to some embodiments. Attendance tracking system 10 includes attendance rules engine 100 having: a web panel application graphic user interface—GUI—(Web GUI) 210 used by a server administrator, school administrators and instructors, and having REST APIs 230 that are accessed by authorized users through a network 150. Attendance tracking system 10 also includes reader application 175 running on personal computer device 170 paired with one or more card-reader devices 160, as described in detail above.

In some embodiments, web GUI 210 is a portal through which the bulk functionality provided by attendance tracking system 10 is accessed by the users. In some embodiments, web GUI 210 includes Responsive Web Design principles such that the same portal is accessed by a plurality of types of personal computing devices 170 including desktops, laptops, and tablets of varying screen resolutions. In some embodiments, web GUI 210 is a module deployed on a separate server in communication with a server hosting attendance rules engine 100, to increase security of attendance tracking system 10. REST APIs 230 provide programmatic access to perform a plurality of tasks in attendance tracking system 10, including: import students, import courses, import course assignments, export class attendance, retrieve device profiles (course and course assignments), and post attendance transactions. Like web GUI 210, REST APIs 230 can be deployed on a separate server to enhance security of attendance tracking system 10.

In some embodiments reader application 175 in personal computer device 170 is provided through web GUI 210. Depending on the type of personal computer device 170 used and the operating system (OS) running it, different native applications may be provided as reader application 175. Some examples may include, without limitation, a reader application 175 built for ANDROID® OS, IOS (for a MAC or APPLE® OS), WINDOWS® RT 8.x OS, and WINDOWS® CE devices. During provisioning, each card reader device 160 is given a unique ID and password. These device credentials, along with the endpoint universal resource locator URL of web GUI 210, are specified during configuration of card reader device 160. Each card reader device 160 may be associated with two (2) different PINs in attendance rules engine 100. Accordingly, a device configuration section of card reader device 160 may be protected by an administration PIN. In addition, a user PIN may protect profile switches for card reader device 160. The device credentials of card reader device 160 may be verified in the communication between Web GUI 210 and personal computer device 170. Accordingly, reader application 175 may be configured to download the configured device profiles of card reader device 160 to personal computer device 170. Once card reader device 160 is activated in personal computer device 170, reader application 175 may read the attendance for a course, listen for card swipe events from card reader device 160, and record check-in and check-out transactions of student 120. In some embodiments, device profile and attendance data from card reader device 160 are encrypted before being stored in personal computer device 170 for offline use. When personal computer device 170 is online, the transactions may be synchronized and transferred to attendance rules engine 100 in server 101. In some embodiments, when personal computer device 170 is offline, data synchronization may occur sporadically as the connectivity to attendance rules engine 100 through network 150 is available.

In some embodiments, attendance rules engine 100 includes an identity management module 227 that performs a form-based authentication, which delegates incoming requests for user authentication to an identity provider wrapper. The identity provider wrapper uses internally one of a transaction challenge/response (e.g., such as provided by TRANSACT™ system) or a lightweight directory access protocol (LDAP) and returns an access token to web panel application 210. In some embodiments, the identity provider wrapper may point to the Transaction System or to the LDAP. The credentials (User Name and Password) are then forwarded to the identity provider and an authorization or deny token is passed back. In that regard, identity management module 227 may implement a challenge/response scheme employing a cryptographically strong hash algorithm. Accordingly, the structure of an access token may include a provision to support claim based security. Identity management module 227 allows other identity services to be used for authentication purposes. In some embodiments, REST API 230 includes the transaction challenge/response provided by identity management module 227 through web GUI 210, for authentication. Identity management module 227 works in close conjunction with a role-based access management module 228 to give more granular security controls. As LDAP transmits communications in clear text, Secure LDAP (LDAPS) will be used wherever possible to take advantage of the encrypted communications.

Role-based access management module 228 uses roles, permissions, and access levels stored in database tables in an attendance management module 221 to provide access and restrictions upon user requests. In some embodiments, web GUI 210 is built using a layered approach. In some embodiments, in addition to an LDAP to transmit communications in clear text, a secure LDAP (LDAPS) may take advantage of encrypted communication. Each user will be mapped to one (1) or more roles, and each role is given permissions to access specific functionality that the system provides. For example, the roles given to the users may be that of student 120, instructor 130, server administrator 110a, school administrator 110b, or department administrator 110c. Authentication will be handled by the Identity Management module 227. Roles, permissions, and access levels are stored in a database, and users are granted access only when the necessary permissions exist. In some embodiments, attendance management module 221 exports class attendance data in a including, without limitation: Course ID, Department, Course Number, Instructor ID, Student ID Number, Transaction Date/Time, and Transaction Result.

Attendance rules engine 100 also includes a device and device profile management module 222. Device profile management module 222 allows reader application 175 to be provisioned through web GUI 210. During provisioning, each reader device 160 is given a unique ID, and password. Device profile management module 222 allows courses and course assignments to be downloaded to reader application 175 in manageable chunks. Profiles will also control whether manual card entry and manual checkout is allowed or not. Device profile management module 222 allows the creation, editing, and deletion of device profiles. The specific configuration of reader device 160 is managed by device and device profile management module 222. For example, when reader device 160 is mobile and is carried around by instructor 130, device profile management module 222 configures reader device 160 to be hosted by personal computer device 170. When reader device 160 is temporarily or permanently fixed to a classroom, device profile management module 222 configures reader device 160 to be hosted by a plurality of personal computer devices 170 associated with the plurality of instructors 130 having a class in the classroom. Further, in some embodiments device profile management module 222 re-configures reader device 160 each semester, quarter, or each institutional term for the course, as class schedules, student rosters, and instructor assignments may vary. In certain aspects, reader applications 175 are allowed to access only the device profiles that are assigned to the device.

Attendance rules engine 100 includes a school management module 223. In some embodiments, one of the administrators 110 uses school management module 223 to provision one or more schools on attendance management module 221. Each school will have a separate administrator 110b, who can further manage other administrators 110 (e.g. a department administrator 110c) and an instructor 130. Each school can have its own LDAP or transaction system for storing user accounts. Attendance tracking system 10 ensures data isolation such that administrators/instructors/devices cannot access another school's data. In some embodiments, attendance tracking system 100 may infer the school ID through a URL for the user accessing server 101, as detected from REST API 230.

Attendance rules engine 100 also includes a cardholder management module 224 that captures information about student 120. Information about student 120 is used for course assignments and attendance tracking. Information about student 120 can be imported from files in a pre-defined file format, manually entered into the system, or automatically ingested into the system using the exposed REST API 230. More generally, credential cardholder data contained in cardholder management module 224 may include, without limitation: Person ID (“Customer Number” in TRANSACT™ system, LastName, FirstName, MiddleName, Active, CardNumber(s) multiple cards may exist for a person.

In some embodiments, attendance rules engine 100 includes a course management module 225 that captures details on instructors 130 teaching the courses, the location of the courses, and class scheduling details. Class scheduling details include information about what day(s) of the week and at what time time(s) the corresponding class or classes are held. Course management module 225 provides information to attendance management module 221 and course assignment module 226. Course data can be imported by course management module 225 from files in a pre-defined file format, or manually entered into the system. In some embodiments, courses can be automatically ingested into the system using REST API 230. Course data in course management module 225 may include, without limitation: Course ID, College/School, Department, Course Number, Course Title, Course Description, Units, Start Date, End Date, Days, Start Time, End Time, Campus, Building, Room, Instructor ID, Instructor Name, Instructor Role, L M S Flag, Instructor ID, Instructor Name, Instructor Role.

Attendance rules engine 100 also includes course assignment management module 226 for the management of course-to-student mappings. These mappings get downloaded to reader device 160 and indicate who can check-in to and check-out from a class at any given time. For example, in some embodiments student-to-course mappings in course assignment module include a student identifier (“Customer Number”) associated with a course ID. The mappings can be imported from files in a pre-defined file format, or manually entered into the system. In some embodiments, the mappings are automatically ingested into the system using REST API 230.

In some embodiments, attendance rules engine 100 creates courses and updates records from data in a feed file. Some examples of feed files include, without limitation, character-delimited flat files or extensible markup language (XML) files that conform to Instructional Management Systems (IMS) standards such as Global Community XML encoding standards, which commonly uses UTF-8. This topic reviews in detail the format of flat files and XML files. In some embodiments of attendance rules engine 100, a SIS Integration feed operation that creates or edits an object (e.g., any non-delete SIS feed operation) may “enable” the object in the feed, unless the feed specifically says that the object should be “disabled.”

In some embodiments attendance rules engine 100 prepares reports to the users accessing each of the different modules described above. The reports are displayed in the web GUI 210 and are available for download in XML and delimited text formats. Search criteria used by REST API 230 include, without limitation: Student Name (First, Middle, Last), Student ID Number, Class Dates, Attendance indicator, Date/Time check-in attendance recorded, Date/Time check-out attendance recorded. A course list report handled by course management module 225 and course assignment management module 226 includes course data such as, without limitation: Course ID, Course Department, Course Number, Course Title, Instructor Name. Student attendance data by course report (i.e., accessible to instructor 130) may include, without limitation: Last Name, First Name, Middle Initial, Student ID Number, Current Day attendance indicator, Previous absence count. Student attendance data by student report (i.e., accessible to student 120) may include, without limitation: Check-in date/time for each class period and Check-out date/time for each class period.

Credential student data from TRANSACT™ or other third party system includes, without limitation: Studentldentifier (Customer Number in Transact), LastName, FirstName, MiddleName, Active, CardNumber(s)—multiple cards may exist for a person. Course data from class registration system includes, without limitation: Course ID, College/School, Department Course Number, Course Title, Course Description, Units, Start Date, End Date, Days, Start Time, End Time, Campus, Building, Room, Instructor ID, Instructor Name, Instructor Role, LMS Flag.

In some embodiments, attendance rules engine 100 is configured to receive class attendance data associated with student 120 from personal computer device 170. Accordingly, attendance rules engine 100 retrieves the attendance parameter when the student 120 activates card reader device 160 coupled to personal computer device 170. The class attendance data may include a course parameter and a student attendance parameter. In some embodiments, the student attendance parameter comprises a multi-factor authentication record including a plurality of ping events for the student during the valid class time for the course. Attendance rules engine 100 is also configured to verify that student 120 is enrolled in the course associated with the course parameter and that the student attendance parameter includes a valid class time for the course. Further, attendance rules engine 100 is configured to update, based on the course parameter and the student attendance parameter, a course record for the course and a student record for student 120. The student record includes historical data representative of the student's attendance for the course. Attendance rules engine 100 may modify an access privilege of student 120 to a service provided by the institution, based on the student record. In some embodiments, the service provided by the institution is one of counseling, an extra course credit, lab time, or access to a campus facility. In some embodiments, attendance rules engine 100 manages setting parameters for card reader device 160 through any one of administrators 110, or instructor 130.

In some embodiments, attendance rules engine 100 provides at least a portion of the updated course record to the user of the personal computer device, and provides at least a portion of the updated student record to the student associated with the student attendance parameter. In some embodiments, attendance rules engine 100 includes a memory storing performance criteria to add or subtract points to a score in the student record, and according to the established performance criteria, trigger a supplemental action to reward or penalize the student according to the score in the student record accrued after a period of time.

In some embodiments, attendance rules engine 100 provides rewards and penalties to student 120 based on the class attendance, a partial class attendance, or a lack of class attendance. Accordingly, a reward includes one of earning a ticket to a campus event, adding value to a campus money card, providing a discount in a campus store, or granting access to a campus facility, and wherein a penalty comprises limiting access to a campus facility. In some embodiments, attendance rules engine 100 provides a certification badge to student 120 upon achievement of an attendance milestone in the student record. The attendance milestone may be determined according to an institutional level outcome, or a program level outcome stored in the memory of attendance rules engine 100 or in database 105, and associated with a specific institution registered with attendance tracking system 10. Attendance rules engine 100 may also allow a third party access to the badge, the third party being authorized by the student or any one of administrators 110. Attendance rules engine 100 may also be configured to receive instructions to modify the course record or the student record when network server 101 is accessed by an authorized user (e.g., administrators 110, or instructor 130). In some embodiments, attendance rules engine 100 receives instructions to modify institutional data associated with the institution when network server 101 is accessed by an authorized user (e.g., any one of administrators 110).

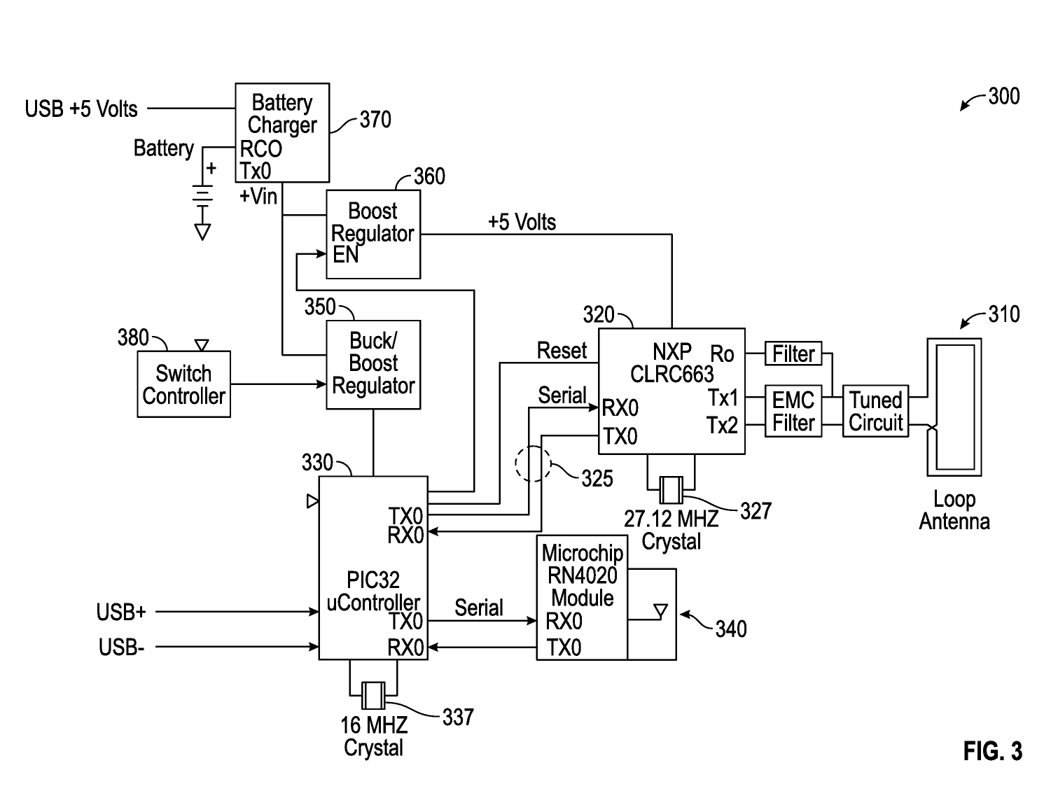

FIG. 3 describes a circuit 300 in a reader device 160 for use in attendance tracking system 10 according to some embodiments. Reader device 160 is configured for reading identification credential 125 using different techniques such as a magnetic stripe, an RFID circuit, a BLE circuit, or an NFC circuit. In some embodiments, circuit 300 includes the above three identification techniques altogether, and even more, such as to accommodate for different types of identification credentials 125 carried by student 120. When identification credential 125 has a magnetic stripe, a card-swipe through notch 163 allows reading of the magnetic stripe. When identification credential 125 includes an NFC circuit in a smart phone or other portable device, an internal antenna in circuit 300 provides the capability to read the NFC credentials.

Circuit 300 includes a switch control 380 to power reader device 160 ‘on’ or ‘off,’ a battery provides up to 40 hours of continuous operation. A battery charger and management circuit 370 controls the battery charging and power path management by sourcing power from either the internal battery or from a universal serial bus (USB) connection. Circuit 300 includes a controller circuit 330, which may be a Microchip PIC32 microcontroller, according to some embodiments. Circuit 300 also includes a transceiver 320 to communicate with host devices such as personal computer device 170 and to receive data from identification credential 125. In some embodiments, transceiver 320 may be an NXP CLRC663, NFC transceiver configured to communicate with an NFC circuit when student 120 uses a smart phone as identification credential 125. In some embodiments, transceiver 320 supports NFC in the unlicensed radio frequency ISM band of 13.56 MHz. In some embodiments, reader device 160 operates in a passive communication mode and supports ISO 14443A/MIFARE® and FELICA™ contactless cards. Transceiver 320 executes commands stored in controller circuit 330 and provided through a link 325. In some embodiments, link 325 is a serial universal asynchronous receiver/transmitter (UART) link. An external crystal 327 may be used as a clock source for transceiver 320. In some embodiments, external crystal 327 has a resonance frequency of 27.12 MHz. This clock signal may be divided by 2 to generate the 13.56 MHz carrier frequency.

The signal delivered on pin TX1 and pin TX2 of transceiver 320 is the 13.56 MHz energy carrier modulated by an envelope signal. In some embodiments, data signal on pins TX1 and TX2 of transceiver 320 at the 13.56 MHz carrier frequency uses 8%-14% of amplitude-shift-keying (ASK). Furthermore, in some embodiments the signal provided by transceiver 320 is Manchester coded at a baud rate of 212 Kbits/second.

In some embodiments, circuit 300 includes an electromagnetic compatibility (EMC) filter that may include a series inductor and parallel capacitor to remove electromagnetic interference (EMI). In some embodiments, additional series and parallel capacitors are used for tuning and impedance matching a loop antenna 310. Furthermore, series resistors may be included to control a quality factor of the antenna. Accordingly, capacitors, resistors, and other electronic components are used in circuit 300 to achieve a 13.56 MHz resonance frequency for appropriate signal shaping according to ISO/IEC 14443. Loop antenna 310 is integrated in a printed wire board (PWB) and desirable includes a larger proportional area within the form factor of reader device 160. In some embodiments, the dimensions of loop antenna 310 are 1.7 inches wide by 3.1 inches in length. The read range of reader device 160 depends on the power available to circuit 300. In some embodiments, the read range of reader device 160 may be approximately 2 inches. The received signal is AC-coupled and filtered at the RX pin of transceiver 320. In some embodiments, circuit 300 includes light-emitting diodes and a speaker to provide audible and visual feedback to the user. The user may be either one of student 120 and instructor 130. For example, in some embodiments reader device 160 may audibly indicate to student 120 that a class attendance has been registered using a speaker in circuit 300.

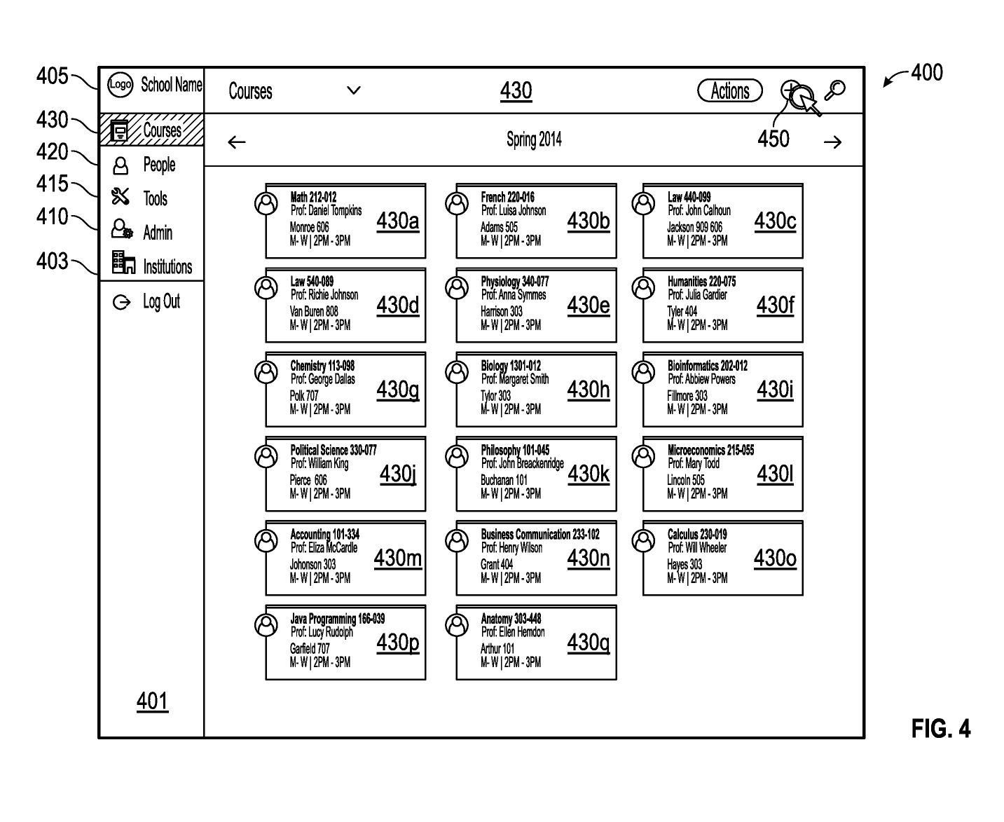

FIG. 4 describes a user display 400 for administrator 110 creating a course and a course timeline in a system according to some embodiments. Display 400 includes a menu 401 indicating a school name 405 for the school that is currently being accessed. Menu 400 includes a courses option 430, a people option 420, a tools option 415, an administrator option 410, and an institutions option 403, from which the user may select. When the user is an administrator 110, it may desire to access courses option 430 to display a plurality of courses 430a-q serviced by attendance rules engine 100.

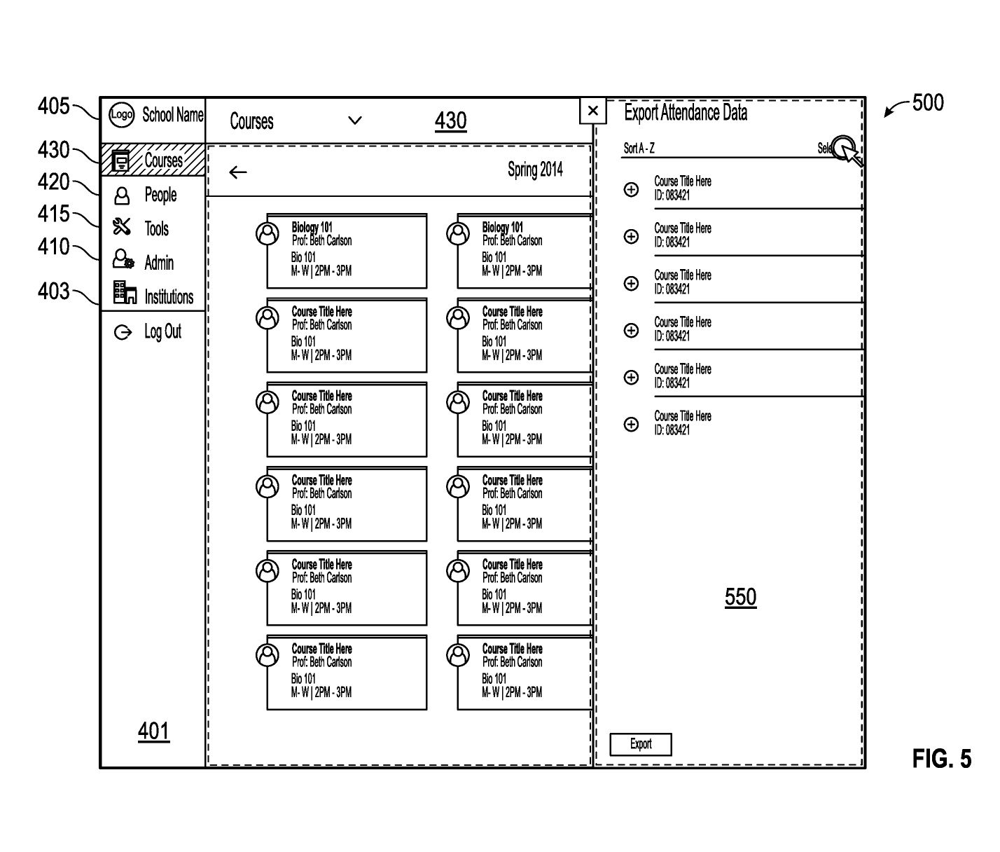

FIG. 5 describes user display 500 for administrator 110 exporting a bulk of attendance data in a system according to some embodiments. Display 500 includes menu 401, school name 405, courses option 430, a people option 420, a tools option 415, an administrator option 410, and an institutions option 403, as described above. An administrator 110 may desire to export attendance data from at least one of a plurality of courses to an authorized recipient by opening an export attendance data option 550. The authorized recipient may be another administrator 110, or a third party. For example, in some embodiments server administrator 110a may export attendance data from one or more courses to school administrator 110b. In some embodiments, school administrator 110b may desire to export course attendance data from one or more course in a department of the school to a department administrator 110c. Further, in some embodiments an administrator 110 may desire to export attendance data related to one or more courses to instructor 130, wherein instructor 130 teaches the courses for which the attendance data is provided.

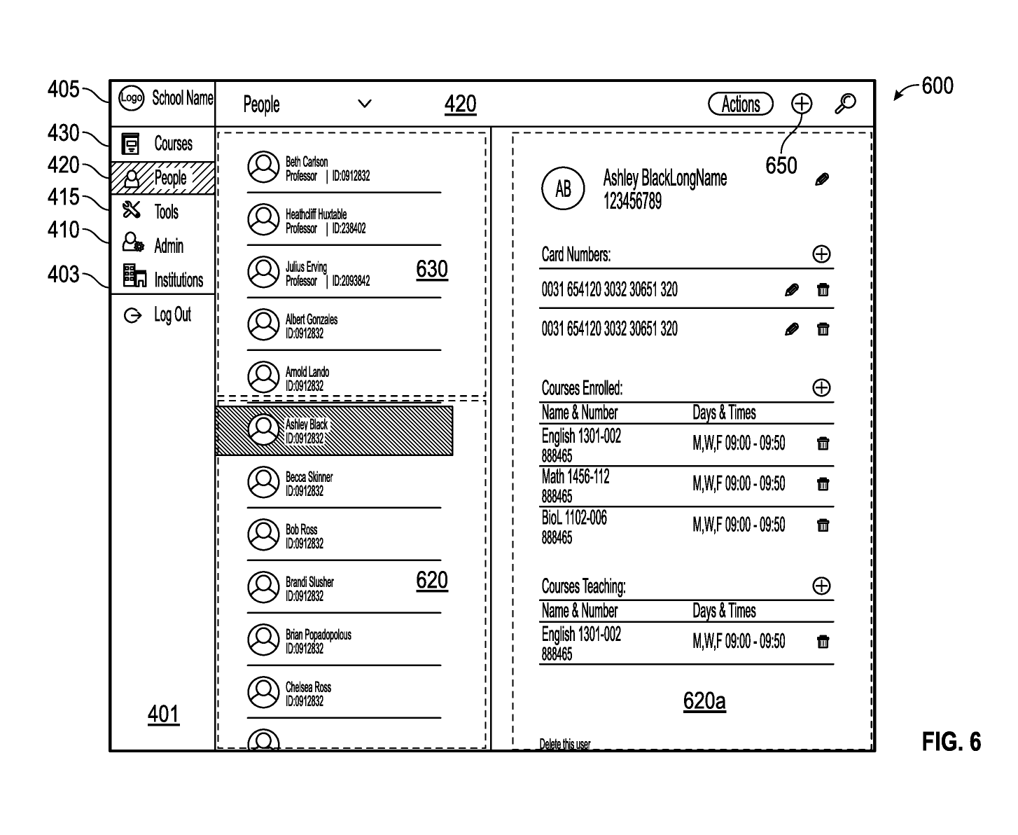

FIG. 6 describes a user display 600 for administrator 110 accessing a card for a student in a system according to some embodiments. Display 600 includes menu 401, school name 405, courses option 430, a people option 420, a tools option 415, an administrator option 410, and an institutions option 403, as described above. Administrator 110 may desire to view, edit, add, or delete a card 620 for a student 120 selected from within people option 420 in the menu. Accordingly, administrator 110 may tap on an actions button 650 to select the desired activity. Display 600 may include a list of instructors 630 and a list 620 of students from which administrator 110 selects to view or edit data for a person of interest (i.e., student 620a).

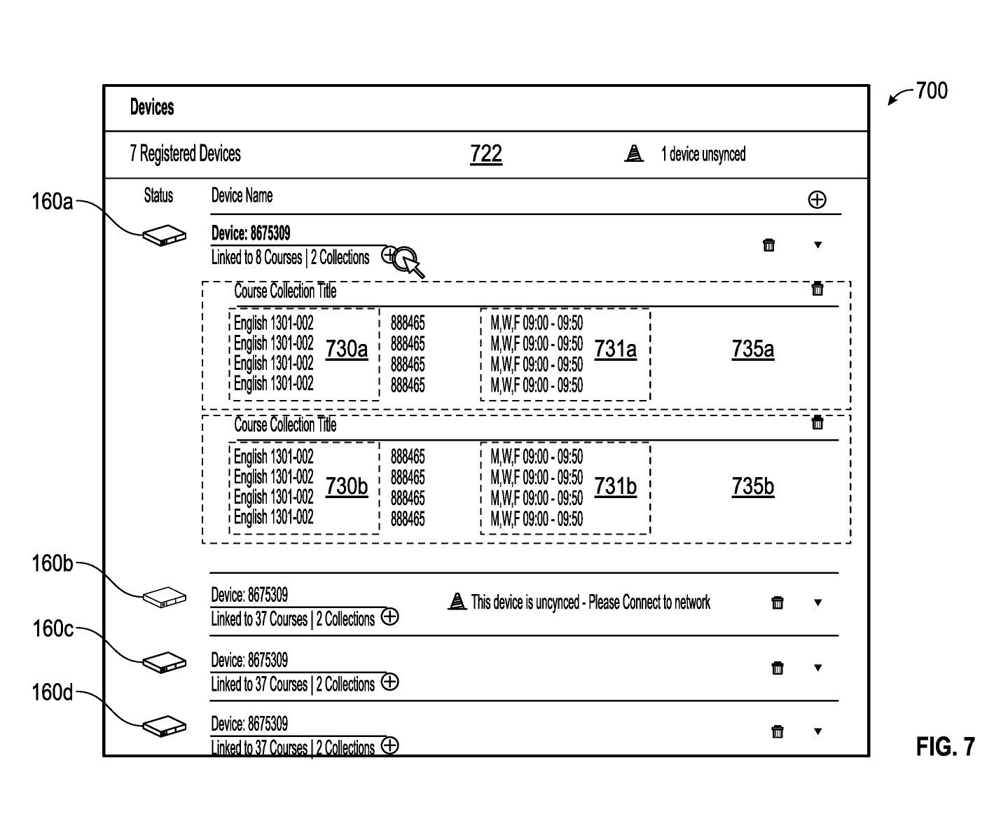

FIG. 7 describes a user display 700 to manage the configuration of a reader device 160 in a system according to some embodiments. The user may be administrator 110 opening a list 722 of reader devices 160a-d registered within attendance rules engine 100. Accordingly, administrator 110 may view, edit, add, delete, or register anew reader device 160 into attendance tracking system 10. Reader device data in display 700 includes, without limitation, a list of course collections 735a,b handled by reader device 160. Each course collection 735a,b may include a plurality of courses 730a,b and a plurality of schedules 731a,b wherein each schedule is associated with a course. In some embodiments, display 700 is provided with data from device and device profile management module 222 in attendance rules engine 100. Also, in some embodiments only a server administrator 110a may have access to display 700.

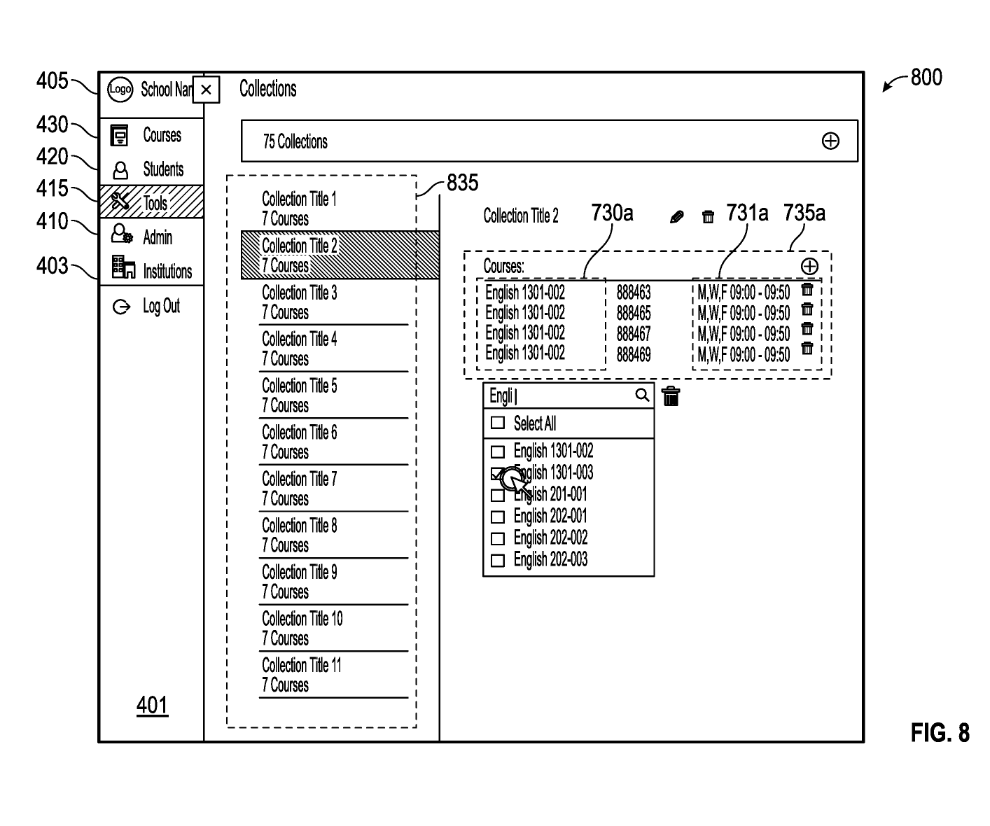

FIG. 8 describes a user display 800 for administrator 110 creating collection 735a of classes in a system according to some embodiments. Display 800 includes menu 401, school name 405, courses option 430, a people option 420, a tools option 415, an administrator option 410, and an institutions option 403, as described above. Accordingly, administrator 110 may open a list 835 of collections 735 selected from tools option 415.

In some embodiments, user display 800 includes administrator 110 opening a course collection 735a and filtering courses 730a to find a specific course, in a system according to some embodiments. Display 800 also includes a list of course schedules 731a.

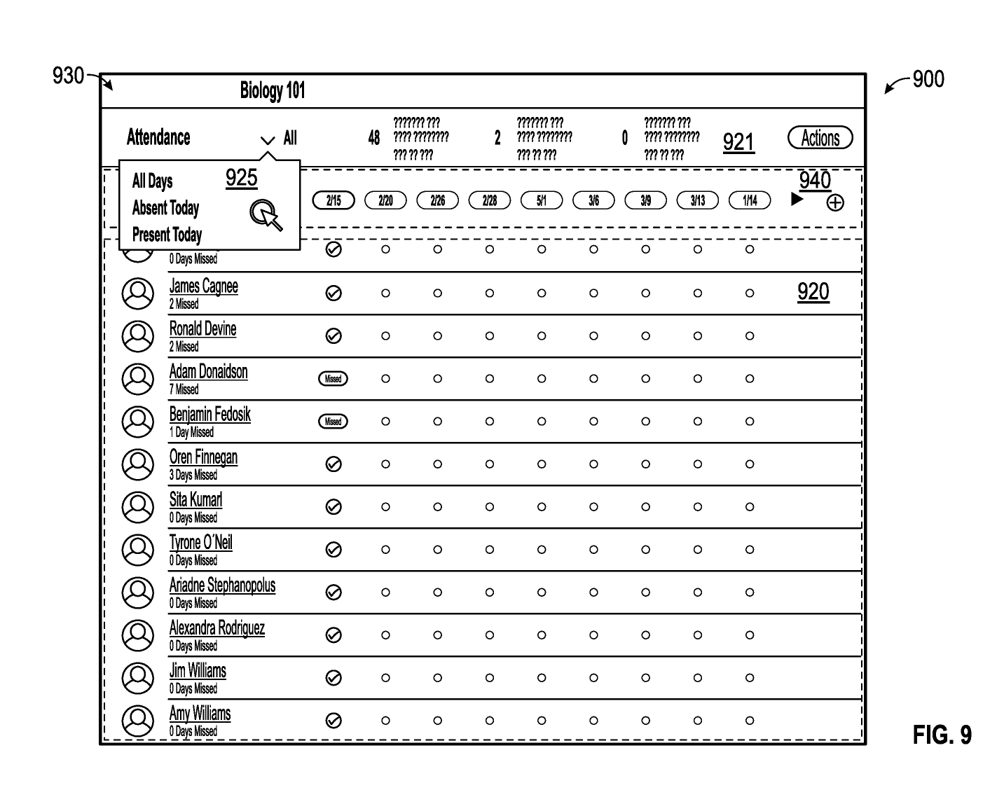

FIG. 9 describes a user display 900 for instructor 130 viewing an attendance list 921 taken for a first day of a class 930 in a term, according to some embodiments. A tab 925 may offer the option of selecting a specific timeline 940 to display the data of a plurality of students 920 registered for the class. In some embodiments, display 900 may be accessible to anyone of administrators 110.

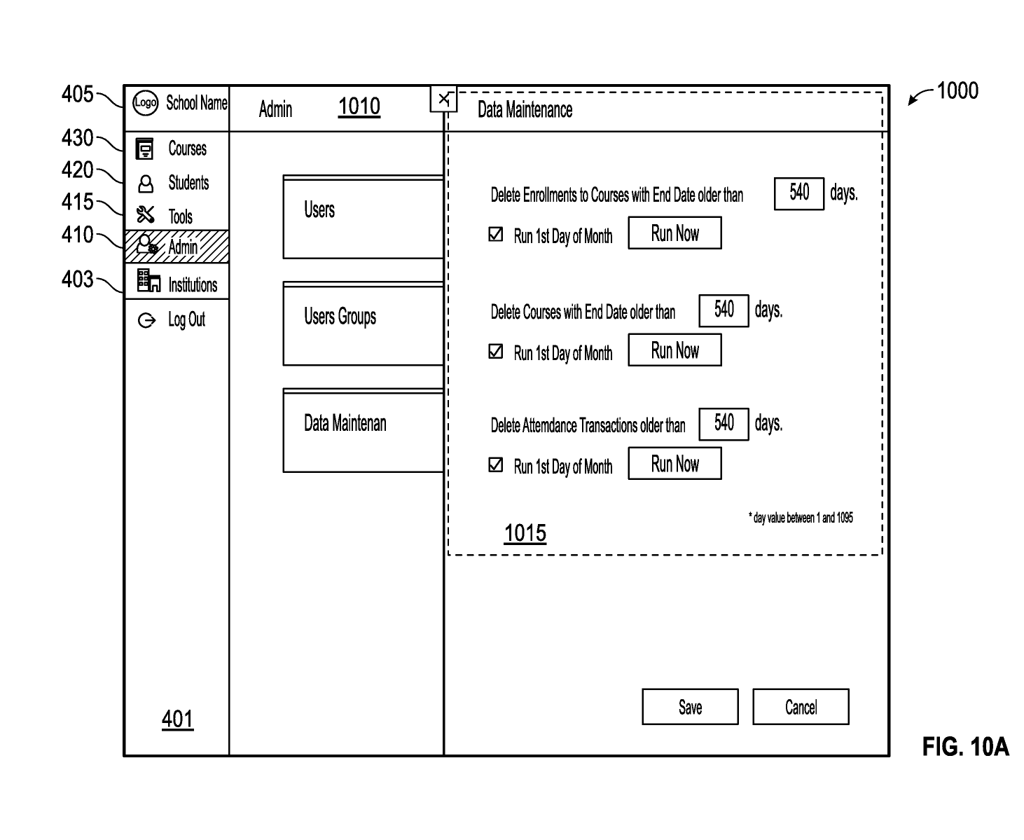

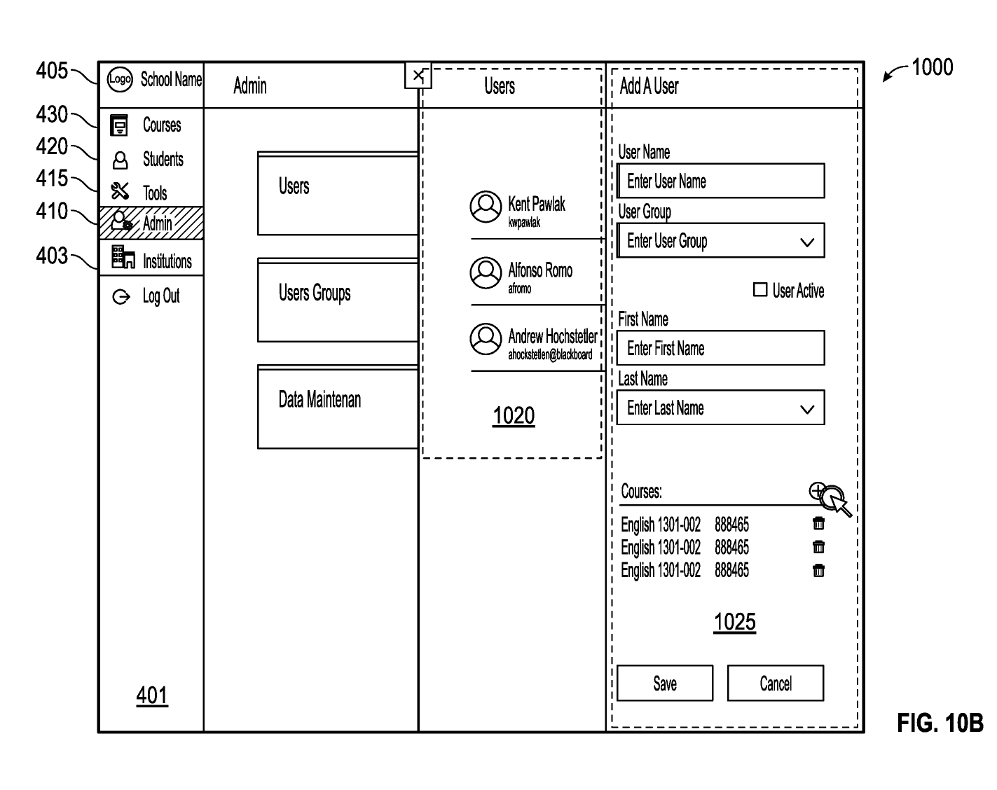

FIG. 10A describes a user display 1000 for administrator 110 performing data maintenance in a system according to some embodiments. Display 1000 includes menu 401, school name 405, courses option 430, a people option 420, a tools option 415, an administrator option 410, and an institutions option 403, as described above. Administrator 110 may desire to perform data maintenance by selecting the administrator option in menu 401. Administrator display 1010 includes administrative options available (e.g., users, user groups, and data maintenance). Display 1000 illustrates a data maintenance option 1015 from which administrator 110 may have access to data from any one of attendance management module 221, school management module 223, course management module 225, identity management module 227, device and device profile management module 222, cardholder management module 224, course assignment management module 226, and role-based access management module 228 in attendance rules engine 100, as described in detail above. Accordingly, display 1000 may be available only to server administrator 110a using personal computer device 115a.

FIG. 10B describes user display 1000 for administrator 110 including users in a system according to some embodiments. Display 1000 includes administrator display 1010 wherein administrator 110 has selected a ‘users’ option. The users option display a ‘users’ list 1020. From users list 1020 administrator 110 may select an action 1025 such as to ‘add’ a user. Note that ‘users’ list 1020 may include any type of user registered with attendance rules engine 100 such as an administrator 110a, 110b, or 110c, an instructor 130, or a student 120.

Systems and methods as disclosed herein may also include attendance badges. Accordingly, attendance rules engine 100 may create and provide attendance badges to students upon achieving a desired attendance record (e.g., has attended a certain number of classes). These attendance badges may be promulgated/published to the server or to any other authority as a behavioral representation of the individual's skills, experience achievement and credentials (e.g. another academic institution for transfer or continued education, or post-graduate education, or a potential employer).

Systems and methods as disclosed herein may also include general rewards and penalties based on the student's tracked attendance. Using the rules engine, an authorized user within the institution customizes a scheme of rewards and penalties based on attendance, partial attendance or lack of attendance, according to some embodiments. Such outcomes may include, but are not limited to, earning tickets to campus events (e.g., sports events, performing arts and other social activities etc.), adding stored-value (e.g., money) to a campus card, providing discounts, granting access to facilities (e.g., labs and student recreational center after normal hours and the like) via the campus card/transaction system. Conversely, access can also be denied for non-desirable attendance behaviors.

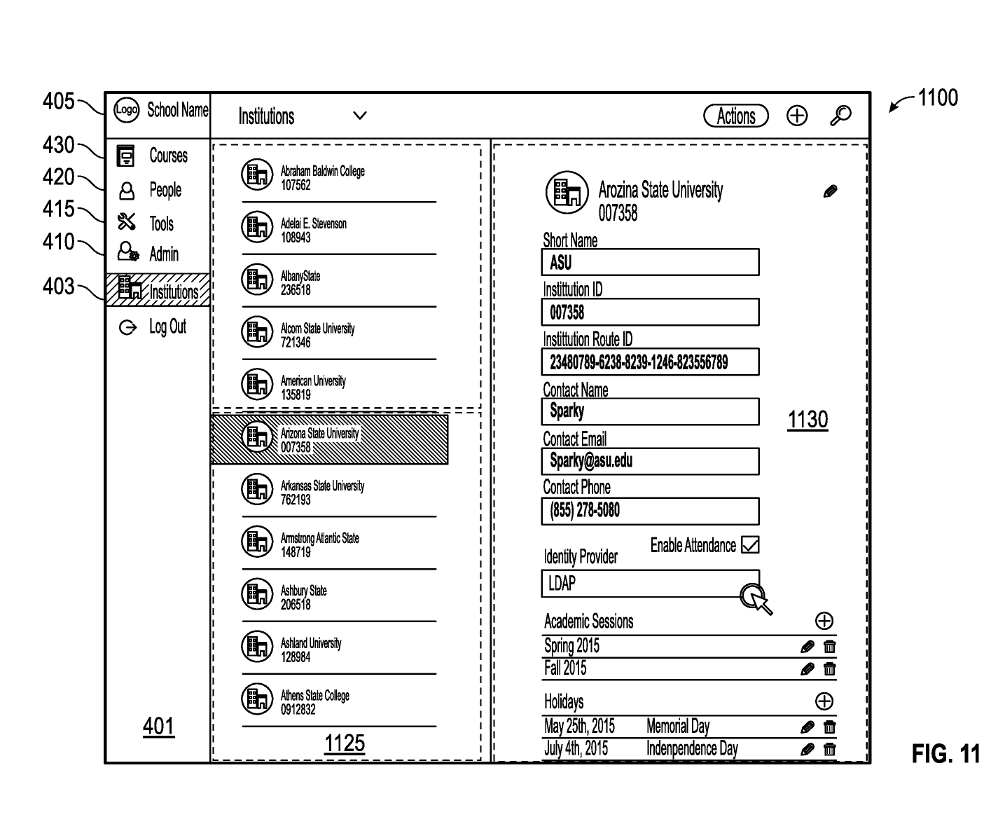

FIG. 11 describes a user display 1100 for viewing and editing institution information in a system according to some embodiments. Display 1100 includes menu 401, school name 405, courses option 430, a people option 420, a tools option 415, an administrator option 410, and an institutions option 403, as described above. Administrator 110 may select institutions option 403 to open a list 1125 of institutions registered with attendance rules engine 100. A field 1130 containing detailed data for a selected one of the plurality of institutions. In some embodiments, display 1100 may be available only for server administrator 110a.

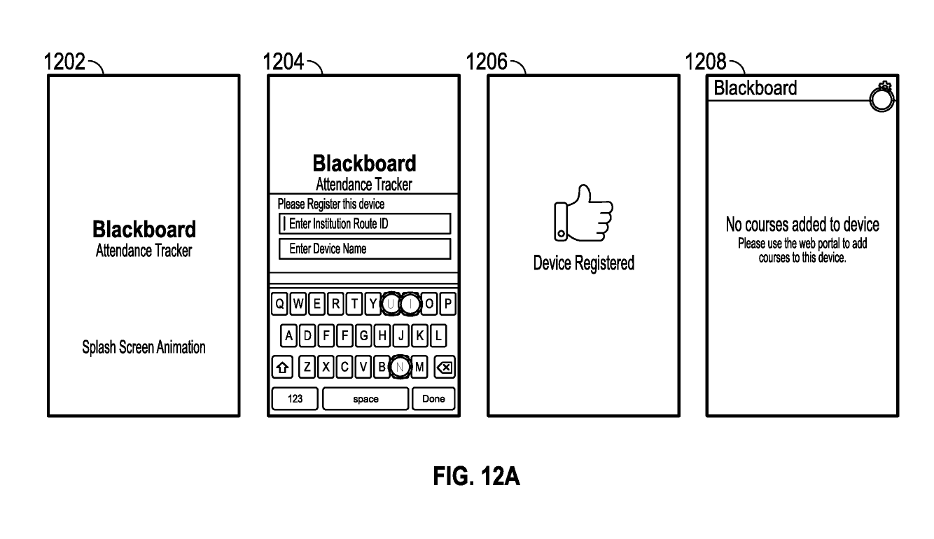

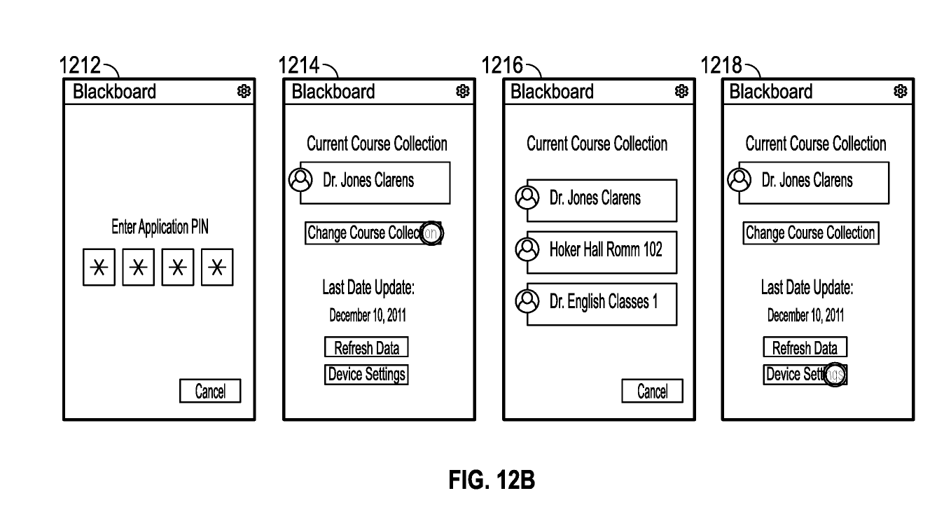

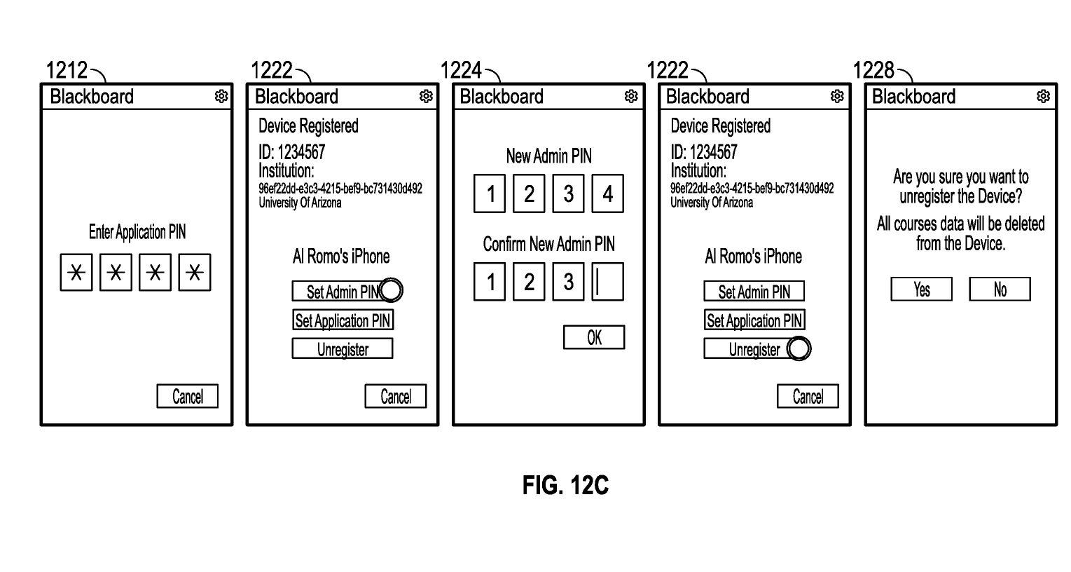

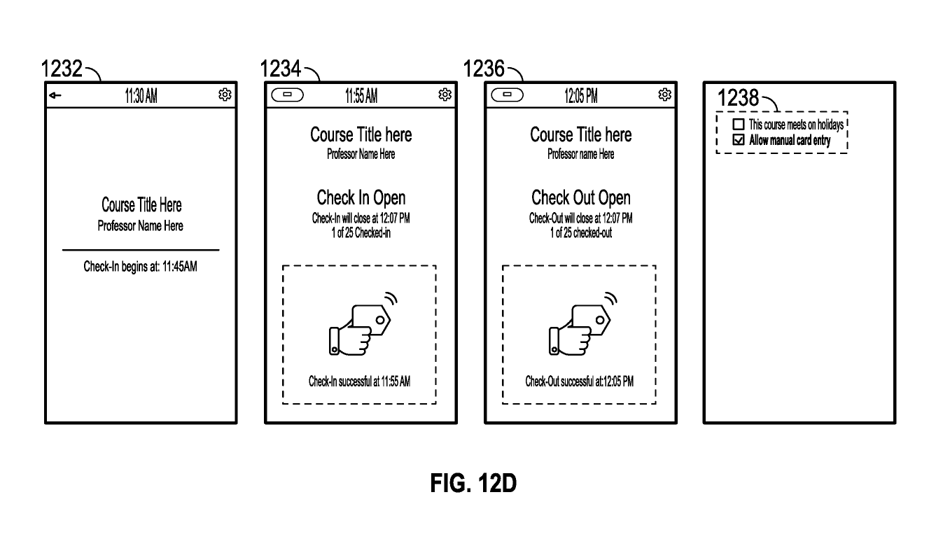

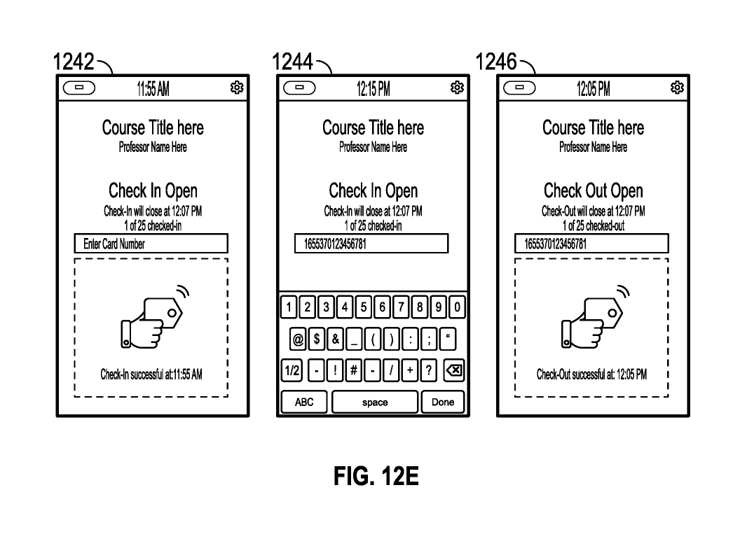

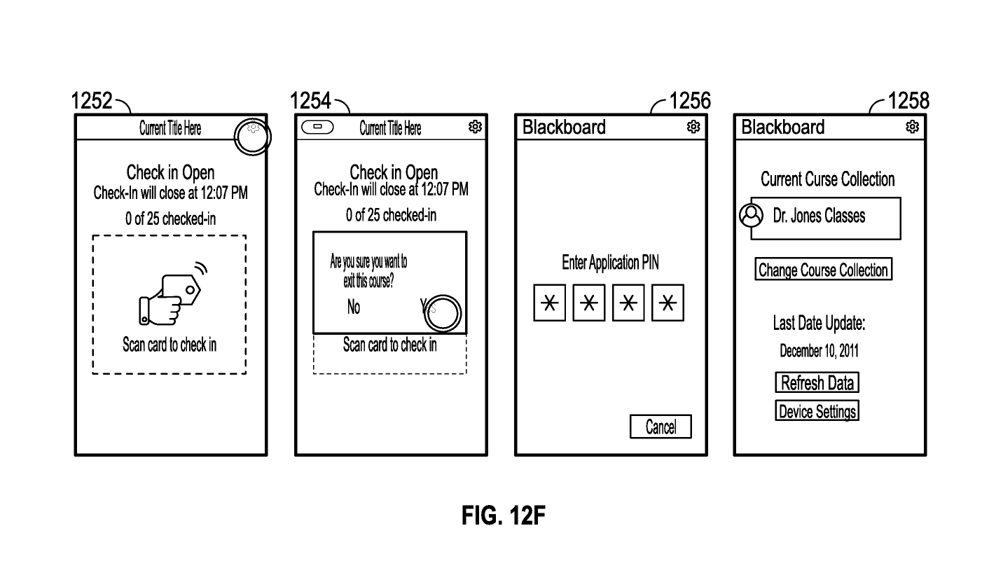

FIG. 12A-F describe a user display 1200 for instructor 130 using personal computer device 170 in attendance tracking system 10, according to some embodiments. Accordingly, FIGS. 12A-F are displays on personal computer device 170 run by reader application 175. In some embodiments, instructor 130 may use personal computer device 170 through reader application 175 to communicate with card reader device 160 in real time, as the class is in progress, or at the time of class check-in (towards the start of class), or at the time of class check-out (towards the end of class). Accordingly, in some embodiments, instructor 130 may conveniently turn reader application 175 ‘on’ before the class begins, and decides when a quorum is sufficient to begin a lecture.

FIG. 12A includes a sequence of an introductory display 1202, a login display 1204, a status display 1206, and a first access display 1208 for registering a card reader device in an attendance tracking system using a personal computer device, according to some embodiments.

FIG. 12B includes a sequence of a PIN display 1212, an updates display 1214, a course collections display 1216, and a current course collection display 1218, for accessing a reader application from a personal computer device, according to some embodiments.

FIG. 12C includes a sequence of PIN display 1212, a device configuration display 1222, a PIN reset display 1224, a device configuration display 1222, and a device un-registration display 1228 for removing a registered card reader device from an attendance tracking system using a personal computer device, according to some embodiments.

FIG. 12D includes a sequence of a course display 1232, a check-in attendance display 1234, and a check-out attendance display 1236 when a manual engagement of card reader device 160 is not enabled and thus the students are checked in or out of the class by waving identification credentials 125 in front of card reader device. Accordingly, instructor 130 may view in real time the number of students engaging card reader device 160 for check-in 1234 and for check-out 1236. A status display 1238 may include accessory information for instructor 130 such as whether a manual card entry is enabled for card reader device 160.

FIG. 12E includes a sequence of a check-in display 1242, a check-in card number display 1244, and check-out a display 1246 when a manual engagement of card reader device 160 is engaged and thus student 120 may enter the number of identification credential 125 manually at check-in to class and or at check-out from class.

FIG. 12F includes a sequence of a check-in display 1252, an interactive display 1254, a password display 1256, and an exit display 1258 for instructor 130 using device 170 to exit the real time view of the attendance flow to the class.

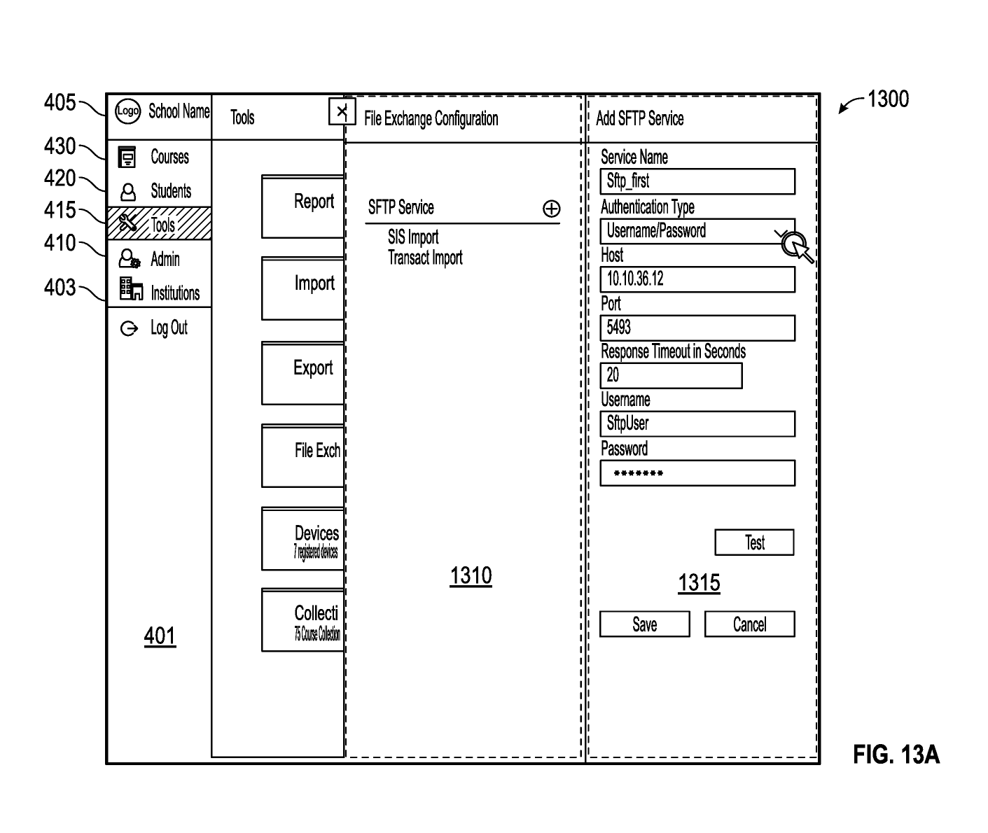

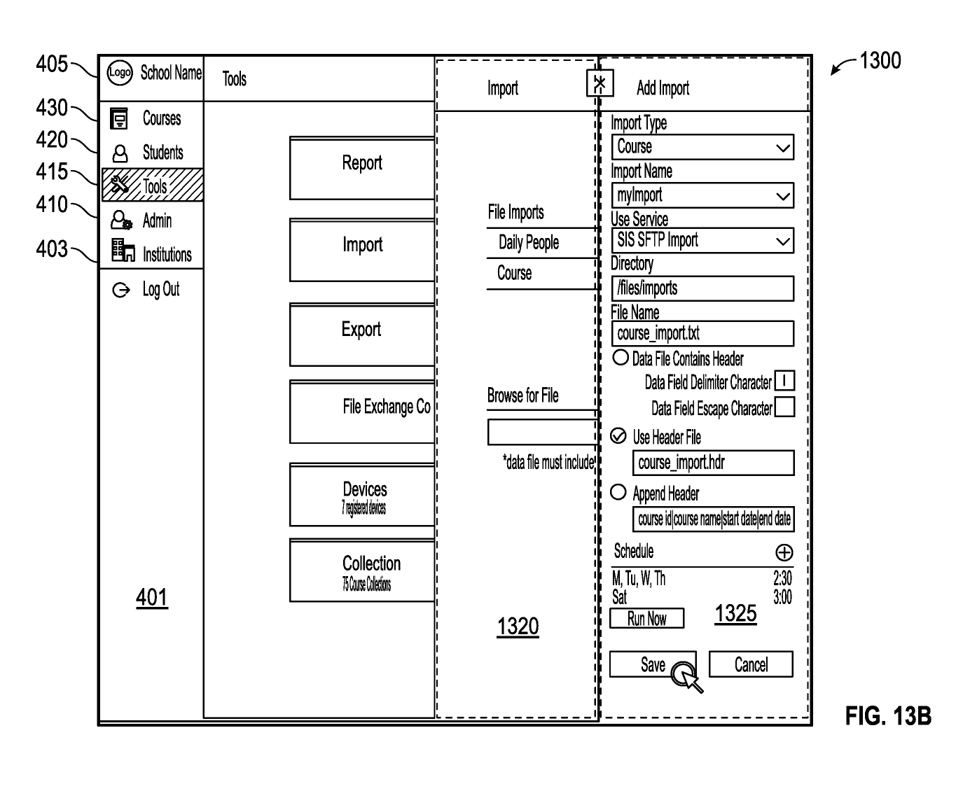

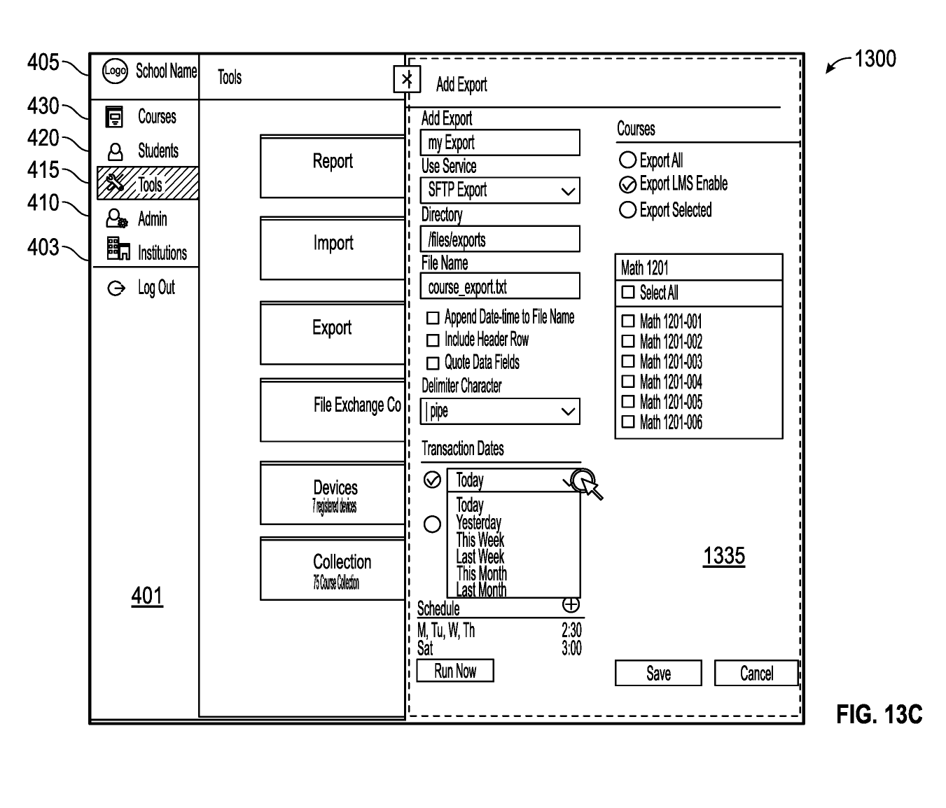

FIG. 13A-C describe a user display 1300 for a tools configuration in a system according to some embodiments. Display 1300 includes menu 401, school name 405, courses option 430, a people option 420, a tools option 415, an administrator option 410, and an institutions option 403, as described above. Administrator 110 may select tools option 415 to open an SFTP service 1310, with an option 1315 to ‘add’ an SFTP service to attendance rules engine 100. Administrator 110 may select tools option 415 to open an import option 1320, from which to add an import selection 1325 (FIG. 13B). Also, administrator 110 may select tools option 415 to open an export option and access export field 1335.

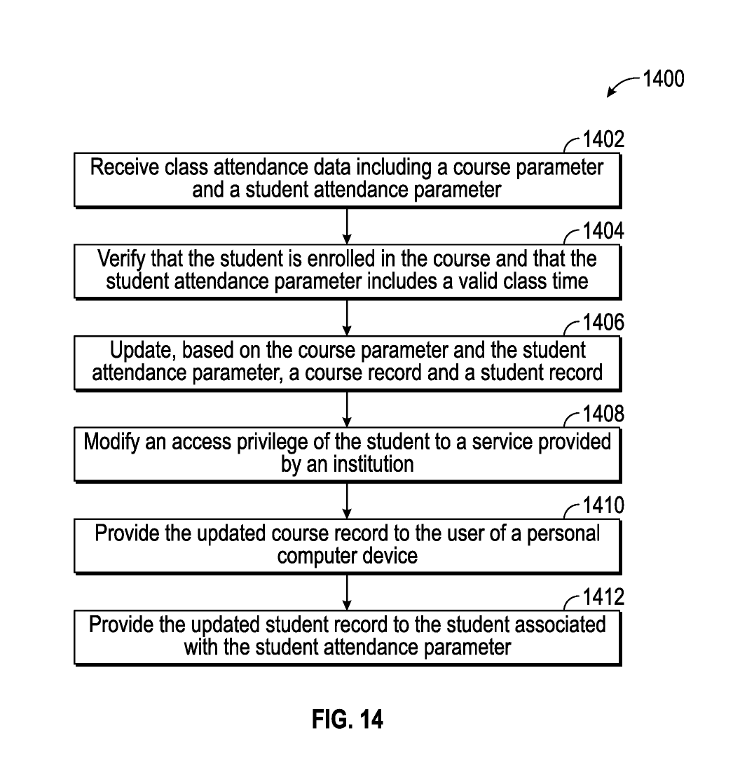

FIG. 14 describes a flow chart with steps in a method 1400 for tracking class attendance by a student in an institution via a network server using a mobile reader device, according to some embodiments. In some embodiments method 1400 is performed by an attendance rules engine communicating through a network with a personal computer device as disclosed herein (e.g., attendance rules engine 100, network 150, and personal computer devices 115 and 170). The attendance rules engine may be hosted by a server coupled to a database, the server and the database being part of an attendance tracking system including a plurality of administrators and at least one institution including a student and an instructor (e.g., server 101, database 105, attendance tracking system 10, administrators 110a-c, student 120 and instructor 130). Accordingly, the plurality of administrators may include a server administrator, a school administrator, and a department administrator. The student may be registered for a course imparted by the instructor in the institution, wherein the course meets with a certain class schedule determined by the institution. Accordingly, the student may use an identification credential to engage a card reader device and register a class attendance for the course (e.g., identification credential 125 and card reader device 160).

Methods consistent with the present disclosure may include at least one, but not all of the steps in method 1400. Moreover, embodiments consistent with the present disclosure may include steps in method 1400 performed in a different order, or even simultaneously or overlapping in time.

Step 1402 includes receiving class attendance data including a course parameter and a student attendance parameter. In some embodiments, step 1402 includes receiving in the class attendance data a multi-factor authentication record including a plurality of ping events for the student during the valid class time for the course. Step 1404 includes verifying that the student is enrolled in the course and that the student attendance parameter includes a valid class time. Step 1406 includes updating, based on the course parameter and the student attendance parameter, a course record and a student record.

Step 1408 includes modifying an access privilege of the student to a service provided by an institution. In some embodiments, step 1408 includes modifying the access privilege based on the student record. In some embodiments, step 1408 may include modifying the course record or the student record when the network server is accessed by an authorized user. The authorized user may be any one of the instructor, the server administrator, the school administrator, or the department administrator. Further according to some embodiments, step 1408 includes receiving instructions to modify institutional data associated with the institution when the network server is accessed by an authorized user. In some embodiments, step 1408 may include adjusting a configuration parameter for the card reader device providing the student attendance parameter to the personal computer device, upon a near field engaging of the card reading device by the student.

Step 1410 includes providing the updated course record to the user of a personal computer device. In some embodiments, the personal computer device transmits the class attendance data to the attendance rules engine. In some embodiments, step 1410 includes providing the updated course record to the instructor, the student, or any one of the administrators in the attendance tracking system, wherein the instructor, the student, or any one of the administrators may use the personal computing device to communicate with the attendance rules engine. Step 1412 includes providing the updated student record to the student associated with the student attendance parameter. In some embodiments, step 1412 includes providing a certification badge to the student upon achievement of an attendance milestone in the student record, and allowing a third party access to the badge, wherein the third party is authorized by the student or an authorized administrator.

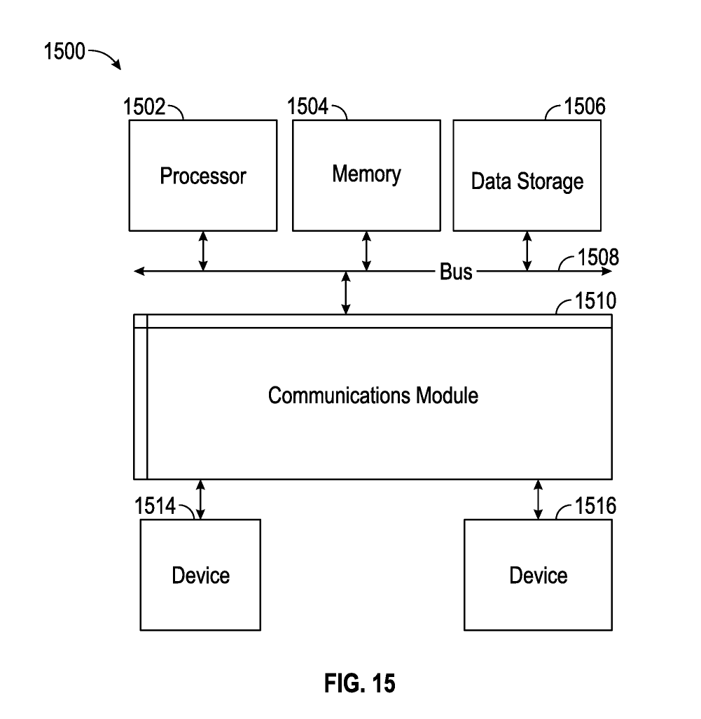

FIG. 15 describes a block diagram illustrating an example computer system 1500 with which the personal computing device and server of FIG. 1 can be implemented, according to some embodiments. In certain aspects, computer system 1500 can be implemented using hardware or a combination of software and hardware, either in a dedicated server, integrated into another entity, or distributed across multiple entities.

Computer system 1500 (e.g., server 101 and personal computer devices 115 and 170, or card reader device 160) includes a bus 1508 or other communication mechanism for communicating information, and a processor 1502 (e.g., rules attendance engine 100) coupled with bus 1508 for processing information. By way of example, computer system 1500 can be implemented with one or more processors 1502. Processor 1502 can be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1500 includes, in addition to hardware, code that creates an execution environment for the computer program in question, e.g., code that constitutes processor firmware, a protocol stack, a database management system, an operating system, or a combination of one or more of them stored in an included memory 1504, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1508 for storing information and instructions to be executed by processor 1502. Processor 1502 and memory 1504 can be supplemented by, or incorporated in, special purpose logic circuitry.

The instructions may be stored in memory 1504 and implemented in one or more computer program products, i.e., one or more modules of computer program instructions encoded on a computer readable medium for execution by, or to control the operation of, the computer system 1500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, embeddable languages, and xml-based languages. Memory 1504 may also be used for storing temporary variable or other intermediate information during execution of instructions to be executed by processor 1502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1500 further includes a data storage device 1506 such as a magnetic disk or optical disk, coupled to bus 1508 for storing information and instructions (e.g., database 105). Computer system 1500 is coupled via communications module 1510 to various devices, such as an input device 1514 or an output device 1516. Device 1514 and 1516 may include other types of devices such as include data ports such as USB ports. Example communications modules 1510 include networking interface cards, such as Ethernet cards and modems. In some embodiments, input device 1514 and output device 1516 may be integrated in the same I/O unit. Example input devices 1514 include a keyboard and a pointing device, e.g., a mouse or a trackball, by which a user can provide input to the computer system 1500. Other kinds of input devices 1514 are used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 1516 include display devices, such as a LED (light emitting diode), CRT (cathode ray tube), or LCD (liquid crystal display) screen, for displaying information to the user.

According to one aspect of the present disclosure, card reader 160 and personal computing devices 115, 170 can be implemented using a computer system 1500. Furthermore, any one or all of the steps in method 1400 can be performed in response to processor 1502 executing one or more sequences of one or more instructions contained in memory 1504. Such instructions may be read into memory 1504 from another machine-readable medium, such as data storage device 1506. Execution of the sequences of instructions contained in main memory 1504 causes processor 1502 to perform the process steps described herein. One or more processors in a multi-processing arrangement may also be employed to execute the sequences of instructions contained in memory 1504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 1500 includes servers and personal computer devices, such asserver 101 and personal computer devices 115 and 170, described in detail above. A personal computing device and server are generally remote from each other and typically interact through a communication network (e.g., network 150). The relationship of client and server arises by virtue of computer programs running on the respective computers and having a client-server relationship to each other. Computer system 1500 can be, for example, and without limitation, a desktop computer, laptop computer, or tablet computer. Computer system 1500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 1502 for execution. Such a medium may take many forms, including, but not limited to, non-volatile media, volatile media, and transmission media. Non-volatile media include, for example, optical disks, magnetic disks, or flash memory, such as data storage device 1506. Volatile media include dynamic memory, such as memory 1504. Transmission media include coaxial cables, copper wire, and fiber optics, including the wires that comprise bus 1508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C. To the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

1. An attendance tracking system for tracking class attendance by a student in an institution via a network, the attendance tracking system comprising:
a memory storing commands; and
a processor configured to execute the commands stored in the memory causing the attendance tracking system to:
receive a class attendance data associated with the student from a personal computer device, the class attendance data comprising a course parameter and a student attendance parameter;
verify that the student is enrolled in the course associated with the course parameter and that the student attendance parameter includes a valid class time for the course;
update, based on the course parameter and the student attendance parameter, a course record for the course and a student record for the student, the student record comprising historical data representative of the student's attendance for the course, the course record and the student record stored in the memory; and
modify an access privilege of the student to a service provided by the institution based on the student record.

2. The system of claim 1, wherein the memory stores commands further causing the system to:
provide at least a portion of the updated course record to the user of the personal computer device; and
provide at least a portion of the updated student record to the student associated with the student attendance parameter.

3. The system of claim 1, wherein the memory stores performance criteria to add or subtract points to a score in the student record, and wherein according to the established performance criteria, the memory stores commands for causing the system to trigger a supplemental action by the processor to reward or penalize the student according to the score in the student record accrued after a period of time.

4. The system of claim 1, wherein the service provided by the institution is one of counseling, an extra course credit, lab time, or access to a campus facility.

5. The system of claim 1, wherein the memory further stores commands for causing the system to provide rewards and penalties to the student based on the class attendance, a partial class attendance, or a lack of class attendance, wherein a reward comprises one of earning a ticket to a campus event, adding value to a campus money card, providing a discount in a campus store, or granting access to a campus facility, and wherein a penalty comprises limiting access to a campus facility.

6. The system of claim 1, wherein the personal computer device retrieves the student attendance parameter when the student activates a card reader device coupled to the personal computer device.

7. The system of claim 1, wherein the processor is further configured to receive instructions causing the system to modify the course record or the student record when the network server is accessed by an authorized user.

8. The system of claim 1, wherein the memory further stores commands for causing the system to provide a certification badge to a student upon achievement of an attendance milestone in the student record, and to allow a third party access to the badge, wherein the third party is authorized by the student or an authorized administrator.

9. The system of claim 1, wherein the student attendance parameter comprises a multi-factor authentication record including a plurality of ping events for the student during the valid class time for the course.

10. The system of claim 1, wherein the processor is further configured to receive instructions causing the system to modify institutional data associated with the institution when the network server is accessed by an authorized user.

11. The system of claim 1, wherein the memory further stores commands for causing the system to manage setting parameters for a card reader device that provides the student attendance parameter to the personal computer device upon a near field activation by the student.

12. A computer implemented method for tracking class attendance by a student in an institution via a network server, comprising:
receiving a class attendance data associated with the student from a personal computer device, the class attendance data comprising a course parameter and a student attendance parameter;
verifying that the student is enrolled in the course associated with the course parameter and that the student attendance parameter includes a valid class time for the course;
updating, based on the course parameter and the student attendance parameter, a course record for the course and a student record for the student, the student record comprising historical data representative of the student's attendance for the course;
modifying an access privilege of the student to a service provided by the institution based on the student record;
storing performance criteria to add or subtract points to a score in the student record; and
according to the established performance criteria, triggering a supplemental action to reward or penalize the student according to the score in the student record accrued after a period of time.

13. The computer implemented method of claim 12, further comprising modifying the course record or the student record when the network server is accessed by an authorized user.

14. The computer implemented method of claim 12, further comprising providing a certification badge to a student upon achievement of an attendance milestone in the student record, and allowing a third party access to the badge, wherein the third party is authorized by the student or an authorized administrator.

15. The computer implemented method of claim 12, further comprising receiving in the class attendance data a multi-factor authentication record including a plurality of ping events for the student during the valid class time for the course.

16. The computer implemented method of claim 12, further comprising receiving instructions to modify institutional data associated with the institution when the network server is accessed by an authorized user.

17. The computer implemented method of claim 12, further comprising adjusting a configuration parameter for a card reader device that provides the student attendance parameter to the personal computer device upon a near field engaging of the card reader device by the student.

18. A non-transitory, computer-readable storage medium storing instructions, which when executed by a processor in a computer, cause the computer to execute a method comprising:
receiving a class attendance data associated with the student from a personal computer device, the class attendance data comprising a course parameter and a student attendance parameter;
verifying that the student is enrolled in the course associated with the course parameter and that the student attendance parameter includes a valid class time for the course;
updating, based on the course parameter and the student attendance parameter, a course record for the course and a student record for the student, the student record comprising historical data representative of the student's attendance for the course;
modifying an access privilege of the student to a service provided by the institution based on the student record; and
storing performance criteria to add or subtract points to a score in the student record, and according to the established performance criteria, trigger a supplemental action to reward or penalize the student according to the score in the student record accrued after a period of time, wherein the service provided by the institution is one of counseling, an extra course credit, lab time, or access to a campus facility.

19. The non-transitory, computer-readable storage medium of claim 18, further comprising modifying the course record or the student record when the network server is accessed by an authorized user.

20. The non-transitory, computer-readable storage medium of claim 18, further comprising providing a certification badge to a student upon achievement of an attendance milestone in the student record, and to allow a third party access to the badge, wherein the third party is authorized by the student or an authorized administrator.
